(19) United States
(12) Patent Application Publication
(10) Pub. No.: US 2008/0088617 A1
(43) Pub. Date: Apr. 17, 2008

(54) Electronic display device

(75) Inventor: Masamichi Izumida, Ryugasaki (JP)

Correspondence Address: OLIFF & BERRIDGE, PLC, P.O. BOX 320850, ALEXANDRIA, VA, 22320-4850, US

(73) Assignee: SEIKO EPSON CORPORATION, TOKYO (JP)

(21) Appl. No.: 11/907,610

(22) Filed: Oct. 15, 2007

(30) Foreign Application Priority Data
Oct. 13, 2006 (JP) 2006-279613

(51) Int. Cl. G06F 17/00

(52) U.S. Cl. 345/418

(57) ABSTRACT

An electronic display device includes a page data acquisition section which acquires page data including display data and text data, a display data buffer, a write processing section which writes the display data into the display data buffer, a display processing section which displays an image on a display section, and a sound generation section which generates text read-out sound. The display processing section switches display processing between a page batch display process for displaying an image of a given page on the display section and a page split display process for displaying an image of a lower portion of a given page in an upper area of the display section and displaying an image of an upper portion of a subsequent page in a lower area of the display section, based on page break determination information included in the text data and the progress of the text read-out process.

Japanese Patent Application No. 2006-279613, filed on Oct. 13, 2006, is hereby incorporated by reference in its entirety.

### BACKGROUND OF THE INVENTION

The present invention relates to an electronic display device.

An electronic display device is known which displays a digitally stored magazine, newspaper, book, and the like. A device which converts text data into sound is also known. Therefore, when display data for displaying an image on the electronic display device includes text data, an electronic display device having a text read-out function can be realized by inputting the text data to a voice synthesis device.

On the other hand, the display data may be generated as image data which does not include text data. When the display data does not include text data, read-out sound cannot be generated from the display data.

Moreover, since the read-out sound cannot be associated with a page break when the display data does not include text data, it is difficult to turn a page at an appropriate timing.

### SUMMARY

According to one aspect of the invention, there is provided an electronic display device having a function of reading out text corresponding to an image displayed on a display section, the electronic display device comprising:

a page data acquisition section which acquires page data including display data and text data;

a display data buffer capable of holding the display data of at least two pages included in the page data;

a write processing section which performs processing for writing the display data into the display data buffer;

a display processing section which performs processing for displaying the image on the display section based on the display data written into the display data buffer; and

a sound generation section which generates read-out sound of text corresponding to the image displayed on the display section based on the text data included in the page data;

the display processing section switching display processing between a page batch display process and a page split display process based on page break determination information included in the text data, the page batch display process displaying an image of a given page on the display section, and the page split display process displaying an image of a lower portion of a given page in an upper area of the display section and displaying an image of an upper portion of a subsequent page in a lower area of the display section.

### BRIEF DESCRIPTION OF THE SEVERAL VIEWS OF THE DRAWING

FIG. 1 is a diagram illustrative of the configuration of an electronic display device.

FIG. 2 is a diagram illustrative of the configuration of an electronic display device.

FIG. 3 is a diagram illustrative of the configuration of an electronic display device.

FIG. 4 is a flowchart illustrative of the operation of an electronic display device.

FIGS. 5A to 5C are diagrams illustrative of the operation of an electronic display device.

FIG. 6 is a flowchart illustrative of the operation of an electronic display device.

FIGS. 7A and 7B are diagrams illustrative of the operation of an electronic display device.

FIG. 8 is a flowchart illustrative of the operation of an electronic display device.

FIG. 9 is a flowchart illustrative of the operation of an electronic display device.

FIG. 10 is a flowchart illustrative of the operation of an electronic display device.

FIG. 11 is a flowchart illustrative of the operation of an electronic display device.

FIG. 12 is a diagram illustrative of the operation of an electronic display device.

FIG. 13 schematically shows an electronic display device.

### DETAILED DESCRIPTION OF THE EMBODIMENT

The invention may provide an electronic display device capable of generating read-out sound and changing a display image corresponding to the read-out sound, even if the display data does not include text data.

(1) According to one embodiment of the invention, there is provided an electronic display device having a function of reading out text corresponding to an image displayed on a display section, the electronic display device comprising:

a page data acquisition section which acquires page data including display data and text data;

a display data buffer capable of holding the display data of at least two pages included in the page data;

a write processing section which performs processing for writing the display data into the display data buffer;

a display processing section which performs processing for displaying the image on the display section based on the display data written into the display data buffer; and

a sound generation section which generates read-out sound of text corresponding to the image displayed on the display section based on the text data included in the page data;

the display processing section switching display processing between a page batch display process and a page split display process based on page break determination information included in the text data, the page batch display process displaying an image of a given page on the display section, and the page split display process displaying an image of a lower portion of a given page in an upper area of the display section and displaying an image of an upper portion of a subsequent page in a lower area of the display section.

According to this embodiment, the read-out sound is generated based on the text data included in the page data. Specifically, the read-out sound can be generated without using the display data. Therefore, this embodiment enables generation of readout sound of text corresponding to the display image generated based on the display data which does not include text data (e.g. display data configured as image data).

According to this embodiment, the text data includes the page break determination information. The page break determination information is information for determining the page break of the text data. The page break determination information may be included in the text data as command information, for example. According to this embodiment, since the text data includes the page break determination information, it is possible to determine the timing at which the sound generation section generates the read-out sound of text at the page break. Therefore, this embodiment enables the page of the display image to be turned in synchronization with the text read-out sound.

A sentence across the pages can be appropriately displayed by displaying an image of the lower portion of a given page in the upper area of the display section and displaying an image of the upper portion of the subsequent page in the lower area of the display section when generating the read-out sound of text at the page break.

According to this embodiment, a page is turned by switching the display process between the page batch display process and the page split display process without scrolling the display screen. Therefore, a page layout including a photograph and a diagram can be appropriately displayed.

(2) In this electronic display device, the display data buffer may include at least two single-page display data buffers, each of which holds the display data for displaying an image of one page.

The single-page display data buffer is a buffer for storing data for displaying an image of one page. Therefore, the page break information need not be included in the display data by utilizing the single-page display data buffer. Specifically, an image of one page can be displayed by displaying an image on the display section based on the display data written into one single-page display data buffer. A page split display can be realized by synthesizing the display data written into two single-page display data buffers.

(3) In this electronic display device, the write processing section may perform processing for writing the display data for displaying an image of one page into each of the single-page display data buffers.

(4) In this electronic display device, the write processing section may perform processing for writing the display data of a new page into the display data buffer in an area in which the display data of a page with the lowest number included in the display data of at least two pages is written.

Specifically, the display data buffer may be used while overwriting the display data buffer. This enables an electronic display device to be realized utilizing a buffer with a small storage capacity.

(5) In this electronic display device, the write processing section may perform processing for writing the display data of the new page when the display processing section switches display processing from the page batch display process to the page split display process.

(6) In this electronic display device, the write processing section may perform processing for writing the display data of the new page when the display processing section switches display processing from the page split display process to the page batch display process.

(7) In this electronic display device, the display data buffer may include three single-page display data buffers.

The three single-page display data buffers may hold the display data of three consecutive pages. The display data indicating a completely displayed image and the display data indicating the preceding and subsequent pages may be held in the three single-page display data buffers. This enables a smooth display transition to the preceding and subsequent pages.

(8) The electronic display device may further comprise a text display processing section which displays text corresponding to the sound generated by the sound generation section on the display section.

(9) The electronic display device may further comprise a display page designation information generation section which generates display page designation information which specifies a display page to be displayed on the display section based on a user's voice;

wherein the display processing section changes the display page based on the display page designation information.

(10) In this electronic display device, the display processing section may switch display processing between the page batch display process and the page split display process at a timing at which the sound generation section reads out text at a page break.

According to this configuration, since the display page can be changed in synchronization with the text read-out timing, a page corresponding to the read-out sound can be displayed.

In this embodiment, the display processing section may switch the display process from the page batch display process to the page split display process at the read start timing of one sentence (or two or more sentences) at the page end, for example. Alternatively, the display processing section may switch the display process from the page batch display process to the page split display process at the read timing of a character at the page end.

In this embodiment, the display processing section may switch the display process from the page split display process to the page batch display process for displaying the subsequent page at the read start timing of a character on the subsequent page. Alternatively, the display processing section may switch the display process from the page batch display process to the page split display process at the read finish timing of a sentence from the page end to the subsequent page.

Some embodiments of the invention will be described below with reference to the drawings. Note that the invention is not limited to the following embodiments. The invention includes configuration in which the elements in the following description are arbitrarily combined.

An electronic display device 1 according to this embodiment (see FIG. 13) has a function of reading out text corresponding to an image displayed on a display section 2, and may be applied to an electronic book and the like.

1. Configuration of Electronic Display Device

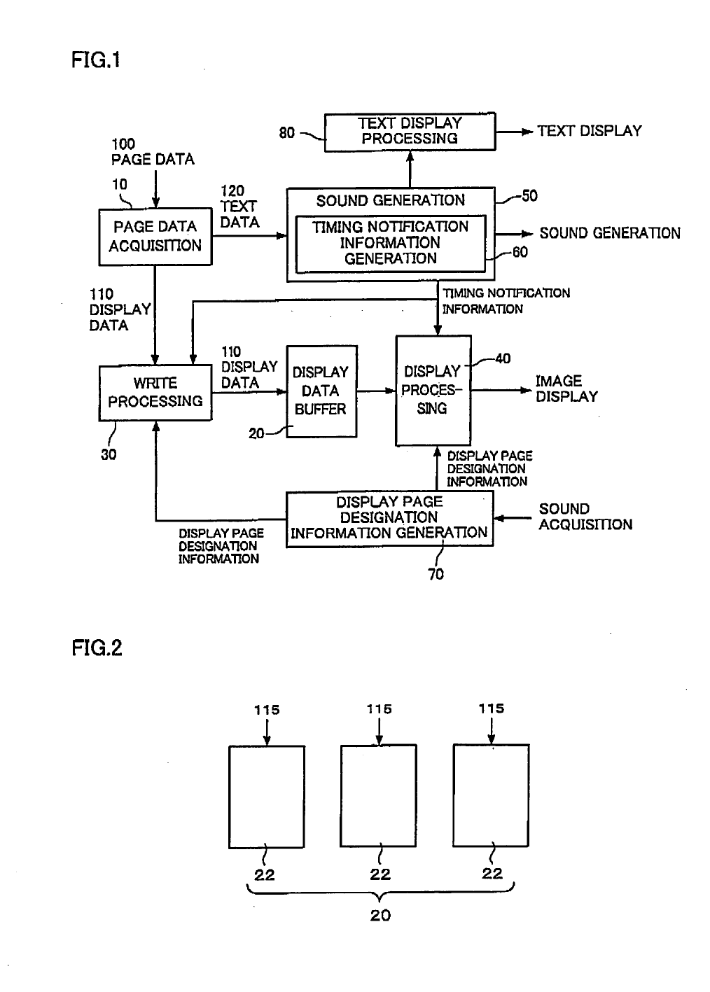

The configuration of an electronic display device 1 according to this embodiment is described below with reference to FIGS. 1 and 2.

The electronic display device 1 according to this embodiment includes a page data acquisition section 10. The page data acquisition section 10 acquires page data 100 including display data 110 and text data 120. The display data 110 refers to data for displaying an image on a display section 2. In this embodiment, the display data 110 is image data which does not include text data. For example, the display data 110 may be image data including a dot pattern and color information. Note that data including text data may be applied to this embodiment as the display data. The text data 120 included in the page data 100 is utilized to generate read-out sound of text corresponding to an image displayed on the display section 2. In this embodiment, the text data 120 includes page break determination information.

The electronic display device 1 according to this embodiment includes a display data buffer 20 for holding the display data 110. The display data buffer 20 is configured to be able to hold the display data 110 of at least two pages. The electronic display device 1 according to this embodiment may be configured so that the display data buffer 20 always holds the display data 110 of two or more pages during operation.

In this embodiment, the display data buffer 20 may include single-page display data buffers 22, as shown in FIG. 2. The single-page display data buffer 22 is a buffer which holds the display data 110 (page display data 115) for displaying an image of one page on the display section 2. In this embodiment, the display data buffer 20 can hold the display data 110 of at least two pages by causing the single-page display data buffers 22 to hold the page display data 115 of different pages. Even if the display data does not include the page break information, the page break of the display data written into the display data buffer can be detected by utilizing the single-page display data buffers 22 as the display data buffer 20, whereby the display image can be changed in page units.

As shown in FIG. 2, the electronic display device 1 may include three single-page display data buffers 22. Note that the invention is not limited thereto. The electronic display device 1 may include two single-page display data buffers 22, or may include four or more single-page display data buffers 22.

The electronic display device 1 according to this embodiment includes a write processing section 30 which writes the display data 110 into the display data buffer 20. The write processing section 30 may extract the display data 110 from the page data 100 acquired by the page data acquisition section 10, and write the extracted display data 110 into the display data buffer 20, for example. When the display data buffer 20 includes two or more single-page display data buffers 22, the write processing section 30 writes the display data 110 (page display data 115) for displaying an image of one page into each single-page display data buffer 22.

In this embodiment, the write processing section 30 may use the display data buffer 20 while overwriting the display data buffer 20. The write processing section 30 may write the display data of a new page into the display data buffer 20 in the area in which the display data 110 of the page with the lowest number is written. A buffer with a small storage capacity can be utilized by overwriting the display data buffer 20.

In this embodiment, the write processing section 30 may write the display data of a new page when a display processing section 40 described later changes the image displayed on the display section 2. For example, the write processing section 30 may write the display data of a new page when the display processing section 40 switches the display process from a batch display process to a split display process. Alternatively, the write processing section 30 may write the display data of a new page when the display processing section 40 switches the display process from the split display process to the batch display process. This enables the display data of pages preceding and subsequent to the page completely displayed on the display section 2 to be always held in the display data buffer 20. This enables smooth switching between batch display and split display.

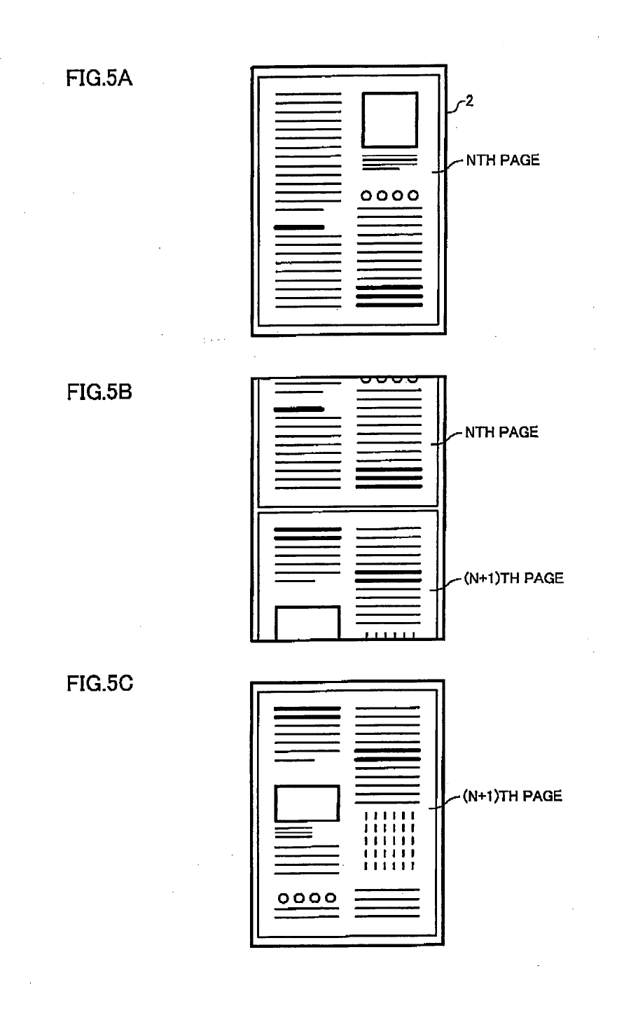

The electronic display device 1 according to this embodiment includes the display processing section 40. The display processing section 40 displays an image on the display section 2 based on the display data 110 written into the display data buffer 20 (single-page display data buffer 22). The display processing section 40 performs a page batch display process for displaying an image of a given page on the display section 2 (see FIG. 5A). The display processing section 40 also performs a page split display process for displaying an image of the lower portion of a given page in the upper area of the display section 2 and displaying an image of the upper portion of the subsequent page in the lower area of the display section 2 (see FIG. 5B).

The display processing section 40 switches the page batch display process and the page split display process based on the page break determination information included in the text data 120. For example, the electronic display device 1 may detect the timing at which a sound generation section 50 described later reads out text at a page break of an image based on the page break determination information, and may perform the switch process at the detected timing (see FIGS. 5A to 5C). This enables the image to be changed at the timing at which the sound generation section 50 reads out text (sound) at a page break. Therefore, the page of the image displayed on the display section 2 can be turned in synchronization with the sound.

The electronic display device 1 according to this embodiment includes the sound generation section 50. The sound generation section 50 generates readout sound of text displayed on the display section 2 based on the text data 120 included in the page data 100. For example, the sound generation section 50 may convert the text data 120 into sound data.

The electronic display device 1 according to this embodiment may include a timing notification information generation section 60. The timing notification information generation section 60 generates timing notification information based on the page break determination information included in the text data 120. The timing notification information refers to information which indicates the timing at which the sound generation section 50 generates read-out sound of text at the page break. For example, the timing notification information is determined by the range of a specific number of characters around the page break position, one sentence including the page break, or the like. The display processing section 40 may change the image displayed on the display section 2 based on the timing notification information. In this embodiment, the timing notification information generation section 60 may be included in the sound generation section 50. Specifically, the sound generation section 50 may generate the timing notification information. Note that the invention is not limited thereto. For example, the page data acquisition section 10 may generate the timing notification information.

The electronic display device 1 according to this embodiment may include a display page designation information generation section 70. The display page designation information generation section 70 generates display page designation information which specifies an image (display page) displayed on the display section 2 based on user's voice. The display processing section 40 changes the display image (display page) based on the display page designation information. The write processing section 30 may write the display data into the display data buffer 20 based on the display page designation information.

The electronic display device 1 according to this embodiment may include a text display processing section 80. The text display processing section 80 displays text corresponding to the sound generated by the sound generation section 50 on the display section 2. Text may be displayed by means of general overlay display or banner display in a specific area. The text display processing section 80 may generate the text data displayed on the display section 2 based on the sound data generated by the sound generation section 50, for example. According to this configuration, the read-out text can be displayed in synchronization with the readout sound.

2. Specific Device Configuration of Electronic Display Device

A specific device configuration of the electronic display device 1 according to this embodiment is described below. FIG. 3 is a diagram illustrative of a specific device configuration of the electronic display device 1.

The electronic display device 1 includes a CPU (central processing unit) 200. The CPU 200 may perform a page data acquisition process, a display data write process, a display process for displaying an image on the display section 2, a sound generation process for generating read-out sound, and a timing notification information generation process, for example. Specifically, the CPU 200 may implement the functions of the data acquisition section 10, the write processing section 30, the display processing section 40, the sound generation section 50, and the timing notification information generation section 60. The electronic display device 1 may include dedicated hardware (circuit) which implement the write processing section 30, the sound generation section 50, and the like.

The electronic display device 1 includes a memory 210. The memory 210 functions as the display buffer 20 (single-page display data buffer 22). The memory 210 is also used as a work area for the CPU 200.

The electronic display device 1 includes an image output section 220 and a sound output section 230. The image output section 220 outputs a display image. The function of the image output section 220 may be implemented by an LCD, an electronic paper, a CRT, a display, or the like. The sound output section 230 outputs sound. The function of the sound output section 230 may be implemented by a speaker, a headphone, or the like.

The electronic display device 1 may include a communication processing section 240. The communication processing section 240 implements communications between the electronic display device 1 and a host computer or the like. The electronic display device 1 may be configured to acquire the page data 100 through the communication processing section 240.

3. Operation of Electronic Display Device

The operating of the electronic display device 1 according to this embodiment is described below.

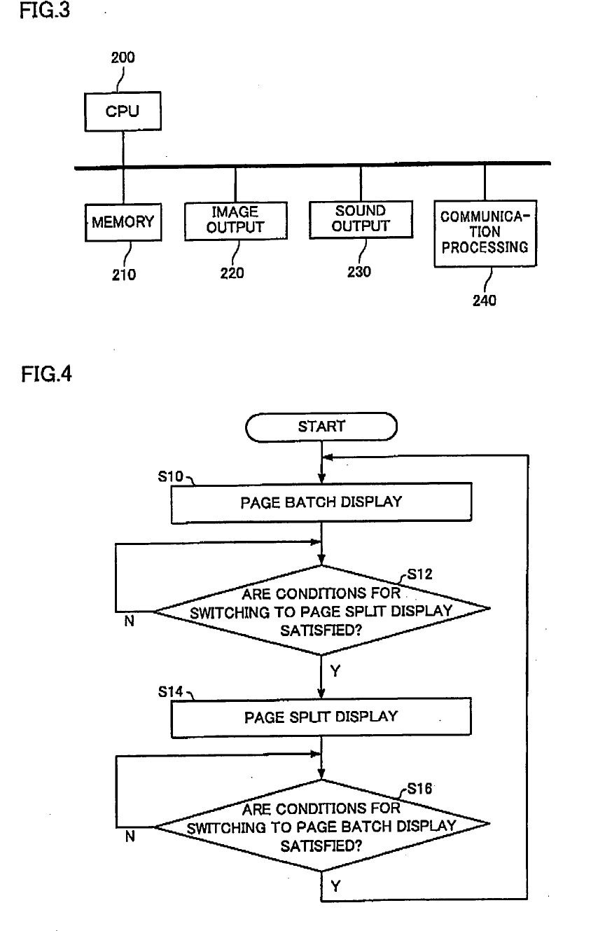

The electronic display device 1 according to this embodiment displays an image on the display section 2. The process of displaying an image on the display section 2 is described below with reference to FIGS. 4 to 5C. FIG. 4 is a flowchart showing the process of displaying an image on the display section 2, and FIGS. 5A to 5C are schematic diagrams showing a state in which an image is displayed on the display section 2.

An image of one page is displayed on the display section 2 based on the display data 110 written into the display data buffer 20 (single-page display data buffer 22). Specifically, the display processing section 40 performs the page batch display process (step S10). In this step, an image of an Nth page is displayed on the display section 2 (see FIG. 5A).

The display processing section 40 continuously performs the page batch display process until the sound generated by the sound generation section 50 satisfies conditions for switching to the page split display (step S12).

When the sound generated by the sound generation section 50 satisfies the conditions for switching to the page split display (Yes in step S12), the display processing section 40 switches the page batch display to the page split display (see FIG. 5B) in which an image of the lower portion of the Nth page is displayed in the upper area of the display section 2 and an image of the upper portion of the (N+1)th page is displayed in the lower area of the display section 2. Specifically, the display processing section 40 performs the page split display process (step S14).

In this embodiment, whether or not the conditions for switching to the page split display are satisfied may be determined based on the page break determination information. For example, it may be determined that the read-out sound satisfies the conditions for switching to the page split display when the sound generation section 50 starts to read out the text at the page break (sentence including the page break), whereby the timing notification information generation section 60 may generate the timing notification information, and the display processing section 40 switches display control to perform the split display process. This enables the sentence across the page break to be displayed appropriately.

The display processing section 40 continuously performs the page split display process until the sound generated by the sound generation section 50 satisfies conditions for switching to the page batch display (or conditions for cancelling page split display) (step S16).

When the sound generated by the sound generation section 50 satisfies the conditions for switching to the page batch display (Yes in step S16), the display processing section 40 displays an image of one page on the display section 2 (step S10). Specifically, the display processing section 40 again performs the page batch display process so that the image of the (N+1)th page is displayed on the display section 2 (see FIG. 5C).

In this embodiment, the conditions for switching to the page batch display may be determined to be satisfied when the sound generation section 50 starts to read out text on a new page (or, when reading of a sentence across two pages has been completed). This enables the page corresponding to the read-out sound to be displayed.

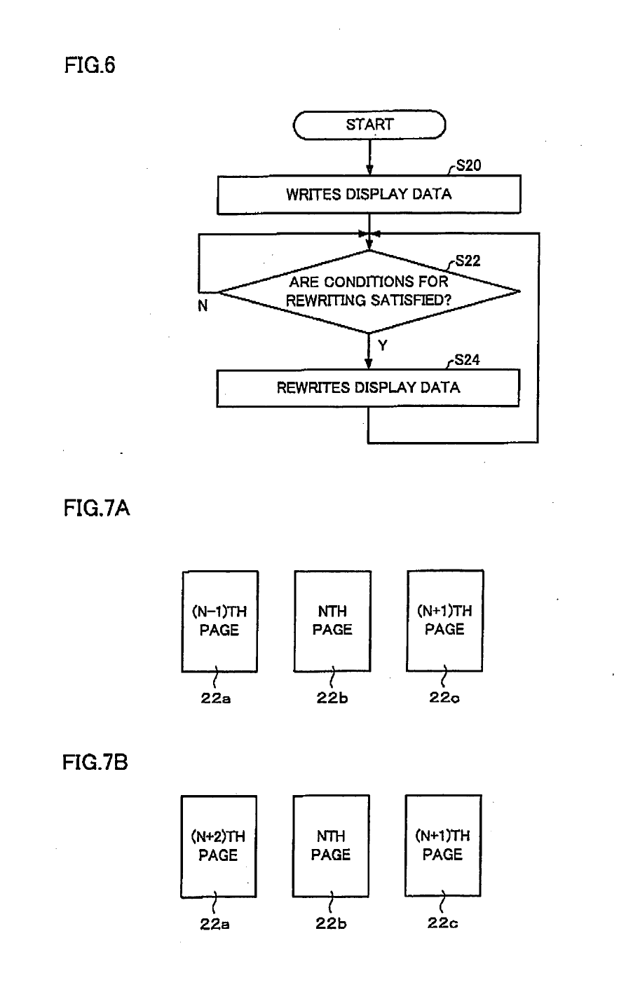

The electronic display device 1 according to this embodiment writes the display data 110 into the display data buffer 20 (single-page display data buffer 22). The process of writing the display data 110 into the display data buffer 20 is described below with reference to FIGS. 6 to 7B. FIG. 6 is a flowchart showing the process of writing the display data 110 into the display data buffer 20, and FIGS. 7A and 7B are schematic diagrams showing a state in which the display data is written into the display data buffer 20 (first to third display buffers 22a to 22c).

The display data 110 is written into the display data buffer 20 (single-page display data buffer 22) (step S20). In this step, the display data 110 of at least two pages is written into the display data buffer 20. When the display data buffer 20 includes three single-page display data buffers 22, the display data of one page is written into each single-page display data buffer 22. In this step, the display data of three consecutive pages (i.e., display data of (N−1)th page, display data of Nth page, and display data of (N+1)th page) is respectively written into the first to third display buffers 22a to 22c, as shown in FIG. 7A.

The display data 110 written into the display data buffer 20 is maintained until conditions for rewriting the display data are satisfied (step S22). When the conditions for rewriting the display data are satisfied, the display data is rewritten (step S24).

In this embodiment, (only) the display data 110 written into the display data buffer 20 in the area in which the display data of the page with the lowest number is written may be rewritten by one data rewrite process. When the display data buffer 20 includes two or more single-page display data buffers 22, the display data of a new page is written (rewritten) into one of the single-page display data buffers 22 in which the page with the lowest number is written. In this embodiment, the display data of (N+2)th page (new page) is written (overwritten) into the first display buffer 22a in which the display data of the (N−1)th page (i.e., the display data of the page with the lowest number written into the display data buffer 20) is written, as shown in FIGS. 7A and 7B.

In this embodiment, the operation of the write processing section 30 may be controlled so that the display data buffer 20 holds the display data of the page completely displayed on the display section 2 and the display data of the subsequent page. This enables the subsequent page to appear smoothly. In this embodiment, the operation of the write processing section 30 may be controlled so that the display data buffer 20 holds the display data of the page completely displayed on the display section 2 and the display data of the preceding page. In this embodiment, the operation of the write processing section 30 may be controlled so that the display data buffer 20 holds the display data of the page completely displayed on the display section 2 and the display data of the preceding and subsequent pages.

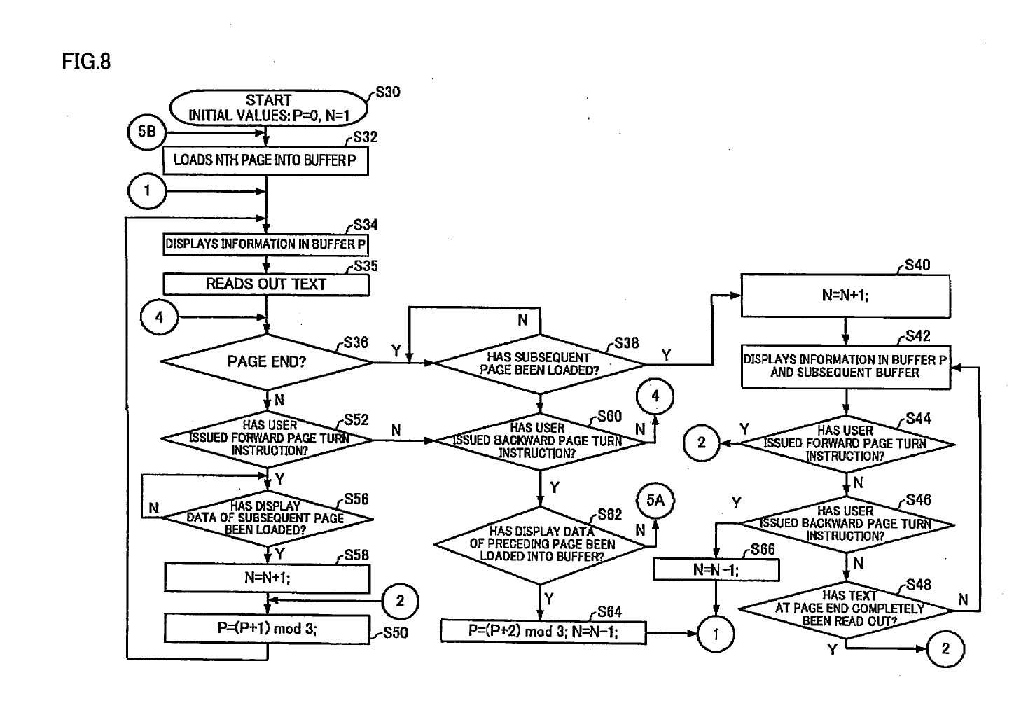

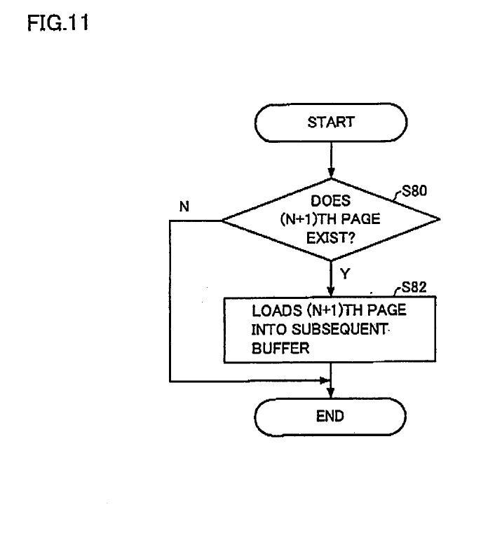

The operation of the entire electronic display device 1 according to this embodiment is described below with reference to FIGS. 8 to 10.

An initial value is set (step S30). The display data of the Nth page is then loaded into a buffer P (step S32), and the information in the buffer P is displayed (step S34).

Text included in the displayed image (text included in the image displayed on the display section 2) is read out (step S35). The text read-out process continues during the subsequent process.

Whether or not the read-out sound corresponds to the text at the page end is determined (step S36). When the read-out sound corresponds to the text at the page end, the split display process is performed. Specifically, when the display data of the subsequent page has been loaded into the buffer (step S38), the parameters are delivered (step S40), and the Nth page and the (N+1)th page are collectively displayed (step S42). The split display is maintained until the text at the page end is completely read out (step S48) as long as the user issues a page turn instruction (steps S44 and S46).

When the user has issued a forward page turn instruction during the split display (step S44), the parameters indicating the buffer are delivered (step S50), and the information in the buffer P is displayed (step S34). When the user has issued a backward page turn instruction during the split display, the parameters are delivered (step S66), and the information in the buffer P is displayed (step S34).

When the user has issued a forward page turn instruction during the batch display (step S52), the parameters are delivered (steps S58 and S50) when the display data of the subsequent page has been loaded into the buffer (step S56), and the information in the buffer P is displayed (step S34). When the user has issued a backward page turn instruction during the batch display (step S60), the parameters are delivered (step S64) when the display data of the preceding page has been loaded into the buffer (step S62), and the information in the buffer P is displayed (step S34).

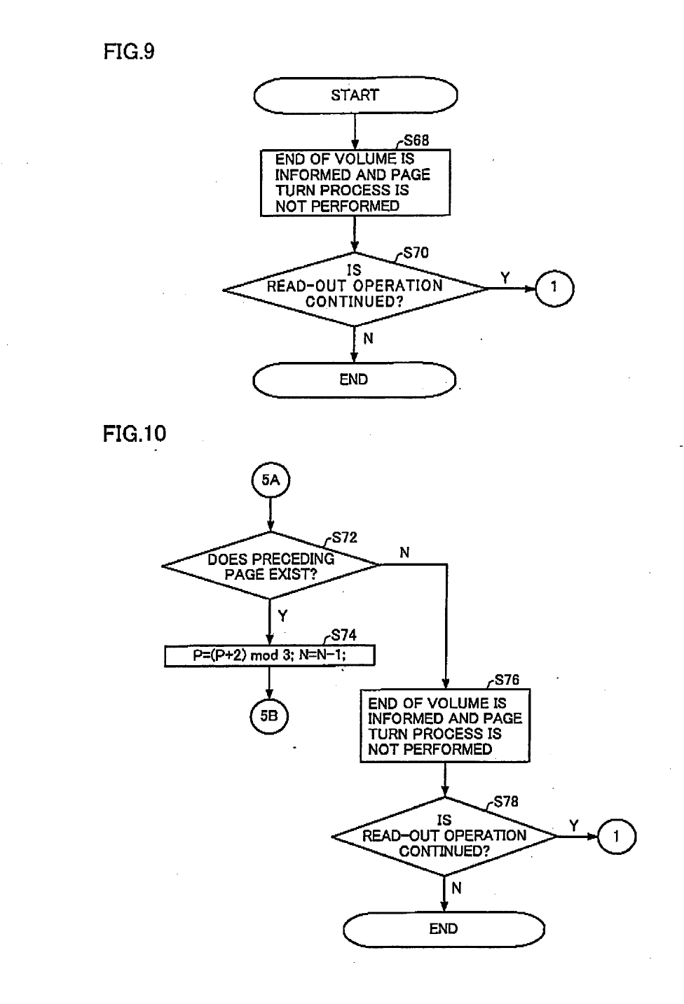

When the page subsequent to the displayed page does not exist, a transition to a step shown in FIG. 9 occurs. For example, when the subsequent page to be expanded does not exist when determining whether or not the subsequent page has been completely expanded (see steps S38 and S56), the user is informed that the end of the volume has been reached, and the page turn process is not performed (step S68). Whether or not to continue the read-out operation is then determined (step S70). When continuing the read-out operation, the information in the buffer P is displayed, and the read-out operation is performed. When terminating the read-out operation, the process is finished.

When the data of the preceding page is not written into the buffer when the user has issued a backward page turn instruction (see step S62), whether or not the preceding page exists is determined (step S72). When the page preceding the displayed page exists, the parameters are delivered (step S74), and the data of the Nth page is loaded into the buffer P (step S32). On the other hand, when the page preceding the displayed page does not exist, the user is informed that the end of the volume has been reached, and the page turn process is not performed (step S76). Whether or not to continue the read-out operation is then determined (step S78). When continuing the read-out operation, the information in the buffer P is displayed, and the read-out operation is performed. When terminating the read-out operation, the process is finished.

In the electronic display device 1 according to this embodiment, the display data of the page subsequent to the Nth page is loaded into the buffer subsequent to the buffer P in parallel with the above-described processes (particularly the process of loading the display data of the Nth page in the buffer P (step S32) and the process of displaying the information in the buffer P (step S34)). Specifically, as shown in FIG. 11, whether or not the (N+1)th page exists is determined (step S80). When the (N+1)th page exists, the display data of the (N+1)th page is loaded into the buffer subsequent to the buffer P (step S82). This enables the display switch process and the like to be performed in a short time.

4. Effect

As described above, the electronic display device 1 according to this embodiment reads out text corresponding to the display image based on the text data 120 included in the page data 100. Specifically, read-out sound of text corresponding to the display image (text included in the display image) can be generated without using the data (display data) for displaying an image on the display section 2.

In the electronic display device 1 according to this embodiment, the text data included in the page data includes the page break information. Therefore, the electronic display device 1 can detect the timing at which the text at the page break is read out. A screen corresponding to the read-out sound can be displayed on the display section 2 by changing the display screen at the timing at which the text at the page break is read out.

In the electronic display device 1 according to this embodiment, the display data held in the display data buffer 20 is changed at the display screen change timing. Therefore, the data of the completely displayed page and the subsequent page can be held in the display data buffer 20. This enables a smooth transition to the subsequent page. The data of the completely displayed page and the preceding and subsequent pages may be held in the display data buffer 20. This enables a smooth transition to the preceding and subsequent pages, thereby making it possible to promptly deal with the user's page turn instruction.

The electronic display device 1 according to this embodiment turns a page while switching the page batch display and the page split display without scrolling the display screen. Therefore, a page layout including a photograph and a diagram can be displayed faithfully (see FIGS. 5A to 5C).

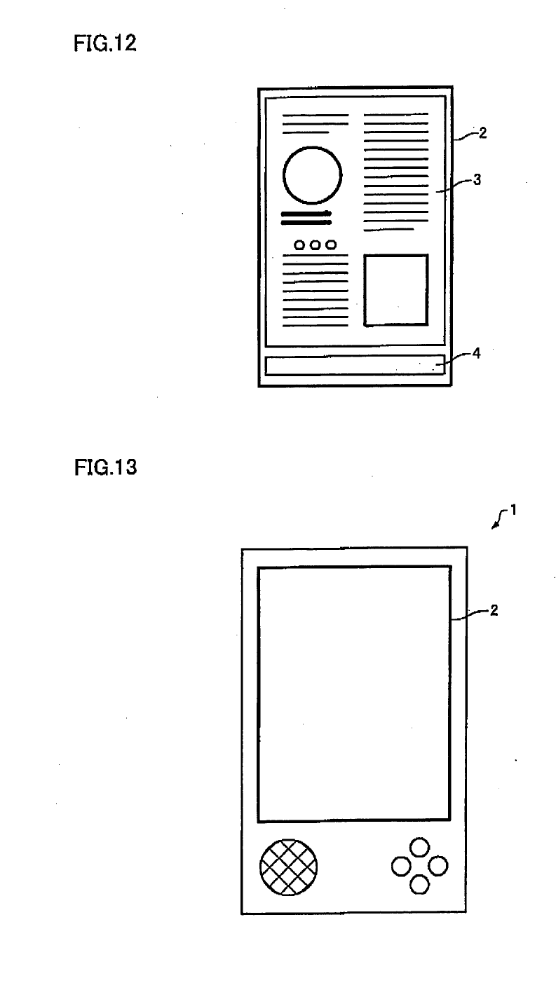

When the electronic display device 1 according to this embodiment includes the text display processing section 80, read-out text corresponding to sound may be displayed on the display section 2. As shown in FIG. 12, a page layout 3 and read-out text 4 may be displayed on the display section 2, for example. This enables the user to visually check the text indicating the readout sound.

FIG. 13 schematically shows the electronic display device 1.

The invention is not limited to the above-described embodiments, and various modifications can be made. For example, the invention includes various other configurations substantially the same as the configurations described in the embodiments (in function, method and result, or in objective and result, for example). The invention also includes a configuration in which an unsubstantial portion in the described embodiments is replaced. The invention also includes a configuration having the same effects as the configurations described in the embodiments, or a configuration able to achieve the same objective. Further, the invention includes a configuration in which a publicly known technique is added to the configurations in the embodiments.

Although only some embodiments of this invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. An electronic display device having a function of reading out text corresponding to an image displayed on a display section, the electronic display device comprising:
a page data acquisition section which acquires page data including display data and text data;
a display data buffer capable of holding the display data of at least two pages included in the page data;
a write processing section which performs processing for writing the display data into the display data buffer;
a display processing section which performs processing for displaying the image on the display section based on the display data written into the display data buffer, and
a sound generation section which generates read-out sound of text corresponding to the image displayed on the display section based on the text data included in the page data;
the display processing section switching display processing between a page batch display process and a page split display process based on page break determination information included in the text data, the page batch display process displaying an image of a given page on the display section, and the page split display process displaying an image of a lower portion of a given page in an upper area of the display section and displaying an image of an upper portion of a subsequent page in a lower area of the display section.

2. The electronic display device as defined in claim 1,
wherein the display data buffer includes at least two single-page display data buffers, each of which holds the display data for displaying an image of one page.

3. The electronic display device as defined in claim 2,
wherein the write processing section performs processing for writing the display data for displaying an image of one page into each of the single-page display data buffers.

4. The electronic display device as defined in claim 1,
wherein the write processing section performs processing for writing the display data of a new page into the display data buffer in an area in which the display data of a page with the lowest number included in the display data of at least two pages is written.

5. The electronic display device as defined in claim 4,
wherein the write processing section performs processing for writing the display data of the new page when the display processing section switches display processing from the page batch display process to the page split display process.

6. The electronic display device as defined in claim 4,
wherein the write processing section performs processing for writing the display data of the new page when the display processing section switches display processing from the page split display process to the page batch display process.

7. The electronic display device as defined in claim 2,
wherein the display data buffer includes three single-page display data buffers.

8. The electronic display device as defined in claim 5,
wherein the display data buffer includes three single-page display data buffers.

9. The electronic display device as defined in claim 6,
wherein the display data buffer includes three single-page display data buffers.

10. The electronic display device as defined in claim 1, further comprising:
a text display processing section which displays text corresponding to the sound generated by the sound generation section on the display section.

11. The electronic display device as defined in claim 1, further comprising:
a display page designation information generation section which generates display page designation information which specifies a display page to be displayed on the display section based on a user's voice;
wherein the display processing section changes the display page based on the display page designation information.

12. The electronic display device as defined in claim 1,
wherein the display processing section switches display processing between the page batch display process and the page split display process at a timing at which the sound generation section reads out text at a page break.

13. The electronic display device as defined in claim 2,
wherein the display processing section switches display processing between the page batch display process and the page split display process at a timing at which the sound generation section reads out text at a page break.

14. The electronic display device as defined in claim 3,
wherein the display processing section switches display processing between the page batch display process and the page split display process at a timing at which the sound generation section reads out text at a page break.

15. The electronic display device as defined in claim 4,
wherein the display processing section switches display processing between the page batch display process and the page split display process at a timing at which the sound generation section reads out text at a page break.

16. The electronic display device as defined in claim 5,
wherein the display processing section switches display processing between the page batch display process and the page split display process at a timing at which the sound generation section reads out text at a page break.

17. The electronic display device as defined in claim 6,
wherein the display processing section switches display processing between the page batch display process and the page split display process at a timing at which the sound generation section reads out text at a page break.

18. The electronic display device as defined in claim 7,
wherein the display processing section switches display processing between the page batch display process and the page split display process at a timing at which the sound generation section reads out text at a page break.

19. The electronic display device as defined in claim 8.
wherein the display processing section switches display processing between the page batch display process and the page split display process at a timing at which the sound generation section reads out text at a page break.

20. The electronic display device as defined in claim 9,
wherein the display processing section switches display processing between the page batch display process and the page split display process at a timing at which the sound generation section reads out text at a page break.
